(19) United States
(12) Patent Application Publication
(10) Pub. No.: US 2004/0237666 A1
(43) Pub. Date: Dec. 2, 2004

(54) Measuring apparatus

(76) Inventors: Laurent Winkenbach, Le Locle (CH); Alessandro Ferraroli, Pregassona (CH)

Correspondence Address: MCGLEW & TUTTLE, PC, 1 SCARBOROUGH STATION PLAZA, SCARBOROUGH, NY, 10510-0827, US

(21) Appl. No.: 10/488,908

(22) PCT Filed: Sep. 13, 2002
(86) PCT No.: PCT/IB02/03776

(30) Foreign Application Priority Data
Sep. 14, 2001 (CH) 1695/01

(51) Int. Cl. G01L 5/12

(52) U.S. Cl. 73/862.49

(57) ABSTRACT

The invention relates to a measuring apparatus that is used to dimension the components of a bicycle according to the user. The inventive apparatus is of the type that comprises a base (10) and a frame (12) which is disposed on the base, the following elements being mounted on said frame: a stem (50) equipped with handlebars (52) to support the arms; a saddle (38) to support the buttocks; a crankset (30) which is used to support the feet; a braking and measuring device (42) which is kinematically connected to the crankset (30) in order to adjust and measure the force exerted by the user; and means for adjusting (20c, 24c, 26c) at least some of the dimensions of the apparatus. Moreover, the inventive apparatus comprises at least one force sensor (58, 60, 62) which is disposed on one of the bearing points and an electronic control system (56) which is connectcd to the force sensor in order to determine the force applied by the user and the evolution thereof over time.

### FIELD OF THE INVENTION

The present invention relates to a measuring apparatus for determining the dimensions of a bicycle such that it fits its user perfectly. Such an apparatus includes:

a stand serving as a base

a frame arranged on the base and, mounted on the frame,

a stem equipped with handlebars serving as a support for the arms,

a saddle allowing the user to sit down,

a crankset, fitted with pedals serving as a support for the feet, and able to move in rotation about a horizontal axis,

a braking and measuring device, kinematically connected to the crankset, for adjusting and measuring the effort exerted by the user, and

means for adjusting at least part of the dimensions of the apparatus.

Through successive tests, such an apparatus enables the conditions of use of the bicycle by an athlete to be determined. It has been observed that the determination of the dimensions of a bicycle can in fact be carried out on the basis of an anthropometric analysis, and more specifically of the skeleton structure. This is not, however, always sufficient, since the muscles also play an important role. It is therefore necessary to carry out static and dynamic tests, which is permitted by the apparatus described hereinbefore.

### SUMMARY OF THE INVENTION

During these tests, the dimensions of the frame, the stem, the handlebars, the crankset and the position of the saddle are modified, until an optimum is found. This optimisation requires numerous trial and error tests and great experience to detect defects, particularly dissymmetry of movement. It is an object of the present invention to facilitate the adjustment operations. This object is attained due to the fact that the apparatus further includes at least one force sensor arranged on one of the points of support and a measuring device connected to the force sensor for determining the force applied by the user and its development over time.

Among the points of support, the pedals play an important role. It is on the pedals that the essential effort is applied. In order to obtain maximum efficiency, the shoe must be perfectly arranged on the pedal. This is why the sensor is arranged to cooperate with the crankset.

In order to allow a static measurement of the pressure exerted on the pedals, the apparatus further includes a removable crankset support, and the sensor is arranged for measuring at least the vertical component of the force statically applied onto at least one of the pedals.

Advantageously, the sensor is arranged for also measuring the horizontal component of the force that is perpendicular to the rotational axis of the crankset.

Such an apparatus is generally fitted with a chain, which connects the crankset to the braking device. Advantageously, the torque variations are measured by means of a sensor arranged for measuring the chain tension.

Comfort on the road substantially depends on the manner in which the user rests on his handlebars. It is, for example, possible for support to occur more on one side than on the other. This can result in increased fatigue on the side that is used more. This is why it is useful for the sensor to be associated with the handlebars. Advantageously, this sensor includes a plurality of membranes, each provided with pressure sensors, arranged at each of the bearing points of the hands on the handlebars.

The position on the saddle is also of great importance, since the contact has to be regular, but with minimum bearing at the perineum. In order to allow the saddle to be properly fitted to its user, a sensor, secured to the saddle, includes a membrane provided with a plurality of sensors distributed over the surface of the saddle, to allow a local pressure measurement.

In order to reveal certain malfunctions, it has to be known in which angular position of the crankset a particular event occurs. This is why the apparatus also includes a position detector cooperating with the crankset in order to determine its angular position with reference to the support.

### BRIEF DESCRIPTION OF THE DRAWINGS

Other advantages and features of the invention will appear from the following description, made with reference to the annexed drawing, in which:

FIG. 1 shows a measuring apparatus according to the invention, and

FIGS. 2 and 3 show parts of said apparatus.

### DETAILED DESCRIPTION OF THE INVENTION

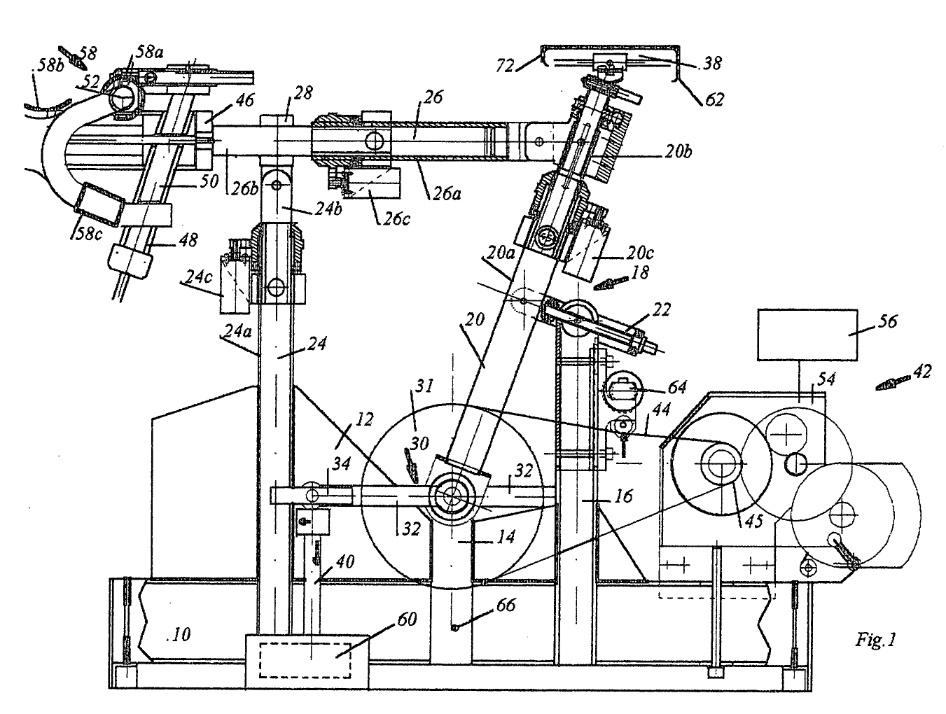

As FIG. 1 shows, the apparatus according to the invention includes a base 10 ensuring its stability on the ground. This base 10 includes three pillars bearing the references 12, 14 and 16, which support a frame 18.

Frame 18 includes a seat post 20, mounted to as to rock on pillar 14 and cooperating with pillar 16 via an adjustable support 22 to allow the inclination of seat post 20 to be adjusted with reference to base 10, a vertical bar 24 rigidly secured to pillar 12 and a horizontal bar 26, one end of which is secured to the upper end of seat post 20, and the median part of which is engaged in a ring 28 comprised in the upper end of vertical bar 24.

Seat post 20 and bars 24 and 26 include two parts identified by the letters a and b, arranged in the extension of each other, and an adjustment member, identified by the letter c and allowing parts a and b to be moved with reference to each other.

A crankset 30 is rotatably mounted on pillar 14, about an axis that merges with the rocking axis of seat post 20. It includes a plate 31, two cranks 32 and two pedals 34, each arranged at the end of one of cranks 32.

A saddle 38 is secured to the upper end of seat post 20. It includes adjusting means for moving it from front to back and inclining it. Since these means are well known to those skilled in the art, they will not, consequently, be described in more detail.

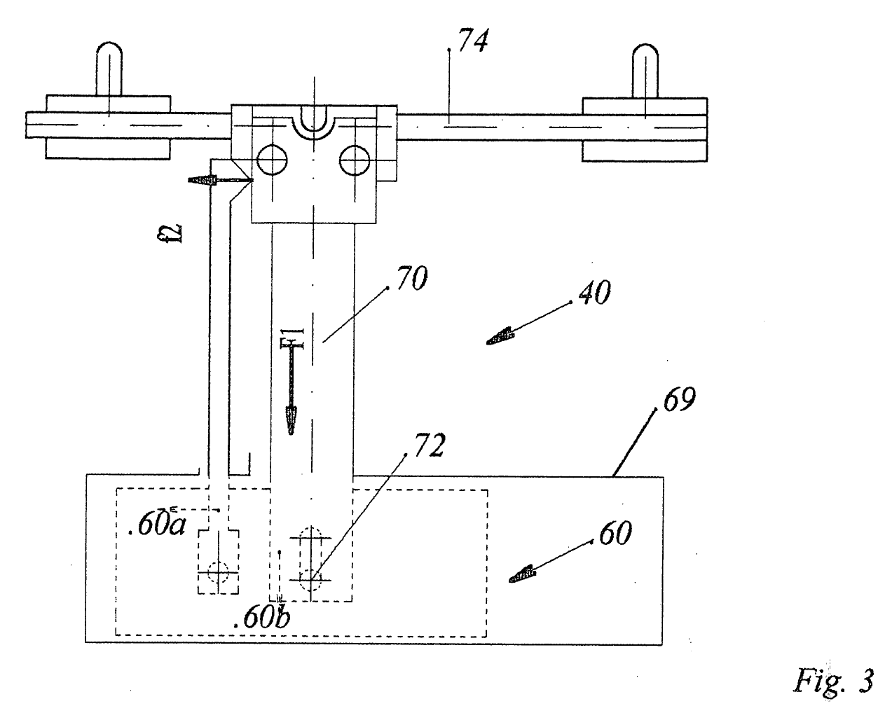

Base 10 also includes pedal supports 40, which are retractable and mobile from front to back, and intended for measuring the static pressure exerted by the user when the crank is horizontal. These supports will be described in more detail with reference to FIG. 3. A braking and measuring device 42 is placed at the back of pillar 16 and connected to plate 31 by a chain 44 and by a toothed wheel 45.

The horizontal 26 is provided, at its end opposite that secured to seat post 20, with a handlebar tube support 46, in which a handlebar tube 48 is engaged. The latter acts as a housing for a stem 50, which carries handlebars 52.

Measuring and braking device 42 essentially includes a generator 54, driven in rotation by wheel 45, and an electronic control unit 56, arranged for adjusting the braking torque. Electronic unit 56 further determines the torque applied and the energy provided as a function of time, the heart rate of the person and allows display of said information.

Such an apparatus enables the dimensions of a bicycle to be fitted to a user's body, and more particularly those of the frame, the crankset and handlebars, and the position of the saddle. In order to do this, the user sits on the apparatus. Advantageously, the latter will have been pre-adjusted from measurements made by means of the apparatus disclosed in CH Patent Application 1983/99, entitled “Anthropometric Measuring Device”. Once installed, the person pedals in conditions that can be modified, simulating, for example, a flat or hilly course, at low speed or maximum effort. Observation of movements during pedalling enables detection of postures likely to cause problems when the person cycles intensively. Such observation is, however, very difficult and requires a lot of experience.

It has transpired that it is possible to facilitate the optimisation work by fitting the apparatus with sensors for measuring the distribution of the forces applied by the person at the different points on which he or she presses. The apparatus shown in the drawing includes, more precisely, three sensors 58, 60 and 62, respectively associated with handlebars 52, pedal support 40 and saddle 38, a sensor 64 for the chain tension, and a crankset position detector 66. These sensors are electrically connected, by means that are not shown in the drawing, to electronic control unit 56, advantageously formed of a computer or a microprocessor.

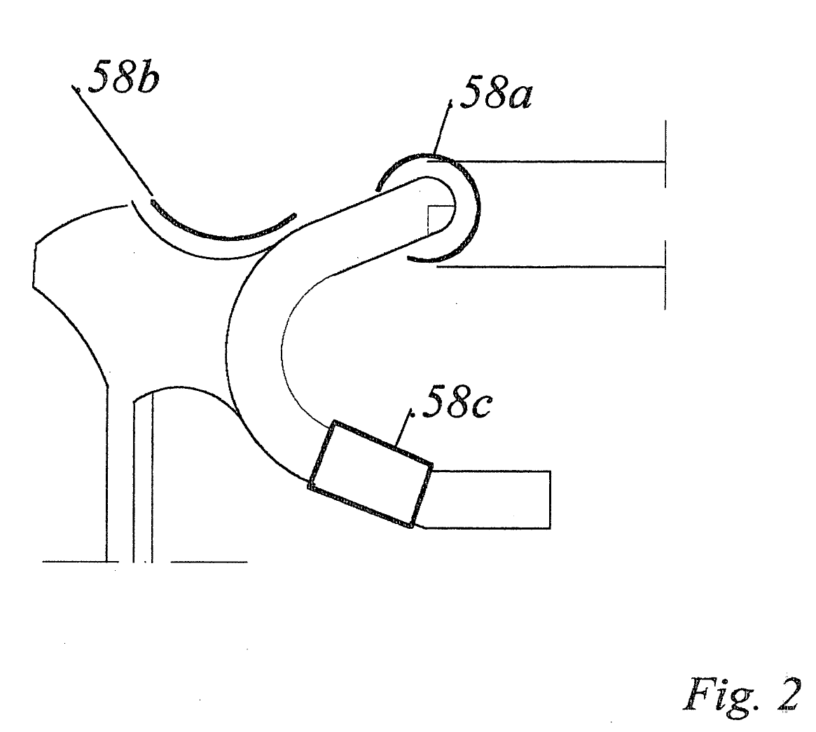

Handlebars 52, fitted with sensor 58, are shown in more detail in FIG. 2. As can be seen in this Figure, sensor 52 is formed of several membranes 58a, 58b and 58c, fitted with integrated pressure sensors. The membranes are fixed onto the bearing points of the hands on the handlebars, respectively close to the stem, on the handrests and on the arched portion of the handlebars. These sensors can be of any type requiring a small thickness, so that the bearing conditions are not affected. Electronic control unit 56, to which they are connected, integrates the pressure measured by each of these sensors and determines the force applied by each of the hands on handlebars 52 at one and/or the other of the bearing points.

By way of variant, it is also possible to arrange sensor 58 on stem 50, and to use strain gauges arranged in an orthogonal manner. These gauges are thus placed such that it is possible to know the intensity and direction of the bearing force of the person on the handlebars. This information is obtained after processing the signals received by electronic control unit 56.

FIG. 3 shows, in more detail, a pedal support 40. This latter includes, in addition to sensor 60, a base 69, a prop 70, a mobile connection 72 of prop 70 on base 69, and a coupling member 74, ensuring a rigid connection between pedal 34 and prop 70, so as to be able to measure the two components of the force applied onto the pedal, one being vertical, the other horizontal, and which are perpendicular to the rotational axis of crankset 30.

Sensor 60 includes two strain gauges 60a and 60b, respectively for measuring the horizontal component and the vertical component of the applied force. These gauges are of the same type as those used in scales, selected so as to be able to bear a load of approximately a thousand Newton. They are connected to electronic control unit 68. It goes without saying that each of the pedals can be associated with a support 40, so as to be able to carry out, in succession, a static measurement for each foot.

In a variant that has not been show, sensor 60 could be secured to cranks 32, formed of three sensors arranged in an orthogonal manner for each crank, and ensuring a dynamic measurement of the intensity and direction of the force applied to each crank.

In such case, the sensor is connected to a circuit for transforming the signals, derived from the sensors, into an electromagnetic signal transmitted to electronic control unit 56 by means of an induction coil and an antenna.

By thus measuring the force applied by the feet onto the pedals, in a static and/or dynamic manner, it is possible to determine whether the plate securing the shoe to the pedal is in the correct position. If this is not the case, the position of the plate can then be adjusted and a new measurement is carried out, to check that the correction was adequate.

Saddle 38 as shown in FIG. 1 is covered with a cushion 72 formed of a membrane, provided with pressure sensors, of the same type as that used for sensor 58. The sensors are arranged in a regular manner on the surface of the cushion in contact with the actual saddle. They thus form a sensor 62 and are connected to electronic control unit 56. They enable the way in which contact occurs between the person's buttocks and the saddle to be determined, and above all determination of whether the load is properly distributed.

Sensor 64 determines the manner in which the user applies the motor torque over time. It is also a strain gauge, measuring a force perpendicular to chain 44.

Sensor 66 is formed of a photoelectric cell arranged to react to each passage of one of cranks 32. It is thus possible to discover, in the measurement diagrams provided by electronic unit 56, at which moment one of the pedals passes through a given point, advantageously its lowest point.

Thus, each of sensors 58, 60 and 62 checks whether the position of the person on the bicycle is correct. Comparison of the information collected by the various sensors thus reveals inadequate postures and allows them to be corrected by adjusting one or other of the dimensions proposed for making the bicycle. These dimensions can then be gradually modified so that an optimum is found.

Comparison of the forces applied to the different bearing points thus allows diagnostic tables to be established showing how the various forces applied vary as a function of time and the corrections to be made when the measurements taken do not correspond to the optimum.

Thus, by fitting the measuring apparatus with sensors associated with at least one of the person's bearing points, it is possible to optimise all or part of the dimensions of the bicycle so that it is fitted as perfectly as possible to the person, taking account of his or her physiological peculiarities and thus avoiding problems connected with exaggerated use of one muscle or member or another.

1. A measuring apparatus for determining the dimensions of the components of a bicycle according to its user, of the type including:
a stand serving as a base
a frame arranged on the base and, mounted on the frame,
a stem equipped with handlebars serving as a support for the arms,
a saddle serving as a support for the buttocks,
a crankset, fitted with pedals serving as a support for the feet, and able to move in rotation about a horizontal axis,
a braking and measuring device, kinematically connected to the crankset, for adjusting and measuring the effort exerted by the user, and
means for adjusting at least part of the dimensions of the apparatus
wherein said apparatus further includes at least one force sensor arranged on one of the bearing points and an electronic control unit connected to the force sensor for determining the force applied by the user and its development over time.

2. An apparatus according to claim 1, wherein a sensor is arranged to co-operate with said crankset.

3. An apparatus according to claim 2, wherein said apparatus further includes a removable crankset support, and wherein said sensor is arranged for measuring at least the vertical component of the force statically applied onto at least one of said pedals.

4. An apparatus according to claim 3, wherein the sensor is arranged also for measuring the horizontal component ofthe force, which is perpendicular to the axis of rotation of the crankset.

5. An apparatus according to claim 1, further including a chain connecting the crankset to the braking device and a sensor arranged for measuring the tension of said chain.

6. An apparatus according to claim 1, wherein a sensor is associated with the handlebars.

7. An apparatus according to claim 5, wherein said sensor includes a plurality of membranes each provided with pressure sensors, arranged at each of the bearing points of the hands on the handlebars.

8. An apparatus according to claim 1, wherein a sensor is arranged on the saddle and includes a membrane provided with a plurality of sensors distributed over the surface of the saddle, to allow a local pressure measurement.

9. An apparatus according to claim 1, further including a position detector cooperating with the crankset in order to discover its angular position with reference to the support.
